(19) United States
(12) Patent Application Publication
(10) Pub. No.: US 2013/0293439 A1
(43) Pub. Date: Nov. 7, 2013

(54) ANTENNA DEVICE

(71) Applicants: Kalyan Sarma, Cambridge (GB); Christopher Lowe, Saffron Walden (GB); Adrian Stevenson, Cambridge (GB)

(72) Inventors: Kalyan Sarma, Cambridge (GB); Christopher Lowe, Saffron Walden (GB); Adrian Stevenson, Cambridge (GB)

(73) Assignee: Sparq Wireless Solutions Pte, Ltd., Pr=etro Centre (SG)

(21) Appl. No.: 13/695,200

(22) PCT Filed: Apr. 27, 2011
(86) PCT No.: PCT/GB11/50830

§ 371 Date: Jun. 26, 2013

(30) Foreign Application Priority Data
Apr. 30, 2010 (GB) 1007349.2

(51) Int. Cl. H01Q 1/50

(52) U.S. Cl. CPC H01Q 1/50
USPC 343/860

(57) ABSTRACT

An antenna for wireless telecommunication comprises a piezoelectric material layer, the piezoelectric material layer being formed such that when an electromagnetic wave is applied thereto, the first piezoelectric material layer is excited at the frequency of the electromagnetic wave. The antenna also comprises an acoustic cavity layer arranged to collect the acoustic energy received from the first piezoelectric layer and first and second electrode layers positioned on either side of the acoustic cavity layer, the electrode layers being arranged to transfer electrical energy to and from both the piezoelectric material layer and the acoustic cavity layer.

The present invention relates to an antenna device constructed from piezoelectric materials for use in wireless telecommunication applications.

Traditionally, antennas for wireless telecommunication have been made from conductive wires and connected to transceivers to transmit and receive radio waves. Resonance of the conductive wire, so a half wave or quarter wave spreads along it, gives efficient electromagnetic radiation and reception at that wavelength and at other harmonics of it.

A significant problem with current antenna construction is that the dimensions of the antenna must be comparable to the wavelength of the electromagnetic waves that are being received or transmitted by them. For higher frequency electromagnetic waves with small wavelengths the use of folded constructions and dielectrics has enabled provision of relatively small antenna components. However, for lower frequencies and longer wavelengths it becomes extremely difficult to produce antennas which are compact and light weight, particularly when for certain applications (particularly where signals need to penetrate deep under ground or under water) the length of the antennas makes it impractical to have a portable and compact construction. In view of this, the conventional approach to reducing the size of antennas has been to reduce the wavelength of communication and accept that transmission of the wavelength may be impaired by barriers such as buildings, mountains etc.

There have been some suggestions to move in a different direction and consider alternatives to electrical construction for antennas, such as piezoelectric resonators. However, such antennas have had intrinsic difficulties in terms of their connection to other components of the transceiver systems to which they may be connected. When piezoelectric resonators are reduced in size (micro-nano) in order to obtain GHz operating frequencies, this coupling problem arises because the supporting electrodes which the piezoelectric material is connected to tend to damp phonons and electrons such that the radio energy fails to reach the receiver.

Accordingly, connection through traditional electrical components provides extremely ineffective coupling, as the components damp the vibrational energy of phonons to the extent that radio energy either fails to reach the receiver or, in the case of transmission, fails to be generated effectively by the antenna. The present invention seeks to overcome these and other problems found in the prior art.

In order to solve the problems associated with the prior art, the present invention provide an antenna for wireless telecommunication, the antenna comprises: a piezoelectric material layer, the piezoelectric material layer being formed such that when an electromagnetic wave is applied thereto, the first piezoelectric material layer is excited at the frequency of the electromagnetic wave; an acoustic cavity layer arranged to collect the acoustic energy received from the first piezoelectric layer; and first and second electrode layers positioned on either side of the acoustic cavity layer, the electrode layers being arranged to transfer electrical energy to and from both the piezoelectric material layer and the acoustic cavity layer.

Preferably, the piezoelectric material layer is arranged to cover at least part of the acoustic cavity layer and part of the first electrode layer.

Preferably, the acoustic cavity layer also comprises piezoelectric material.

Preferably, the piezoelectric material layer comprises a layer of nanowires disposed perpendicularly with respect to the second piezoelectric material layer.

Preferably, the piezoelectric material is formed of zinc oxide; the acoustic cavity layer is formed of quartz; and the first and second electrode layers are formed of gold.

Preferably, the acoustic cavity layer comprises: a round thick support layer; and a co-centric round thin mesa region disposed in the centre of the round thick support layer.

Preferably, the mesa region comprises a first and a second surface, and the first and second electrode layers are arranged to cover at least a portion of the first and second surfaces of the mesa region.

Preferably, a further piezoelectric material layer is provided on the second electrode layer.

Preferably, the further piezoelectric material layer is formed of zinc oxide nanowires.

Preferably, the antenna further comprises: electric field generating means for generating a direct current electric field around at least one of the piezoelectric layer and the acoustic cavity layer, the electric field generating means being arranged to vary the intensity of the direct current electric field in order to tune the resonant frequency of the antenna.

The present invention also comprises a transceiver for wireless telecommunications, the transceiver comprising an antenna in accordance with any of the preceding claims.

As will be appreciated, the present invention provides several advantages over the prior art. For example, traditional antennas have dimensions which must be comparable to the wavelength of the electromagnetic waves that are being received or transmitted by them. By using the present invention however, it is possible to produce a self-contained radiofrequency chip which merges semiconductors with nanowire array antennas. The present invention is therefore useful in a wide range of applications, such as WiFi applications and mobiles phones. The present invention will however be particularly useful in applications which require relatively low frequency communication in order to pass around and through barriers. Such applications include Global Positioning System (GPS) in buildings, miners' radios, divers' radios, submarine radios, hybrid antenna and transceiver chips and miniaturised Radio Frequency Identification (RFID) chips.

Moreover, prior art nanowire antennas have not been able to efficiently collect electromagnetic signals at their acoustic resonance frequency, as their supporting electrodes damp phonons and electrons such that the radio energy fails to reach the receiver. The present invention solves this problem by extracting the vibrational energy of the nanowires with a second piezoelectric element before passing the signal to the receiver.

An example of the present invention will now be described with reference to the accompanying drawings, in which:

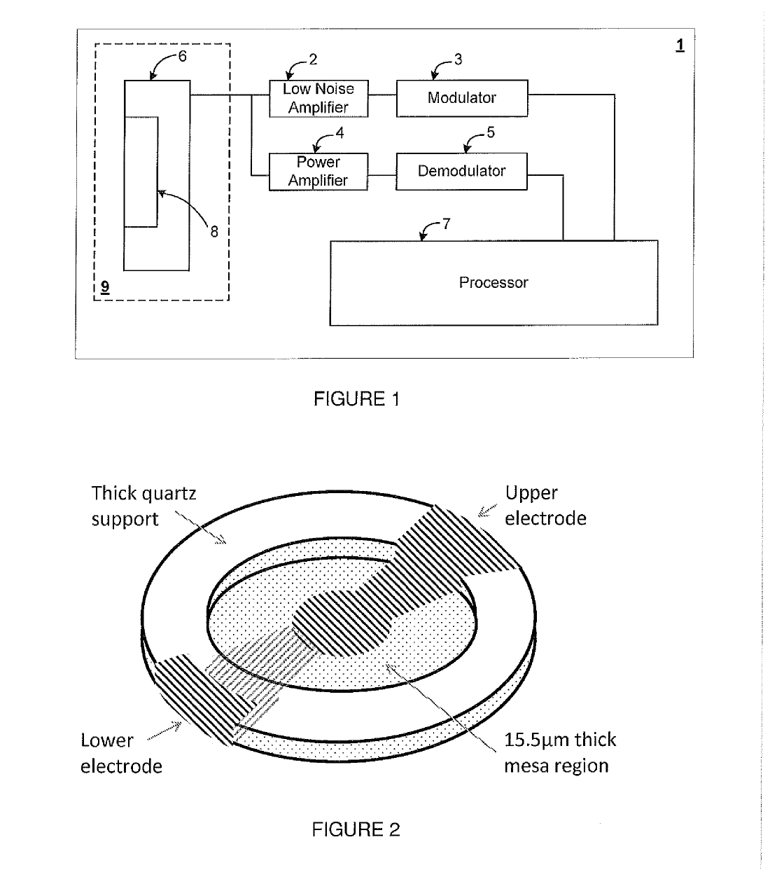

FIG. 1 is a schematic diagram of a transceiver in accordance with one embodiment of the present invention;

FIG. 2 is a partial schematic diagram showing the construction of an oscillator contained in the oscillator carrier of the transceiver of FIG. 1;

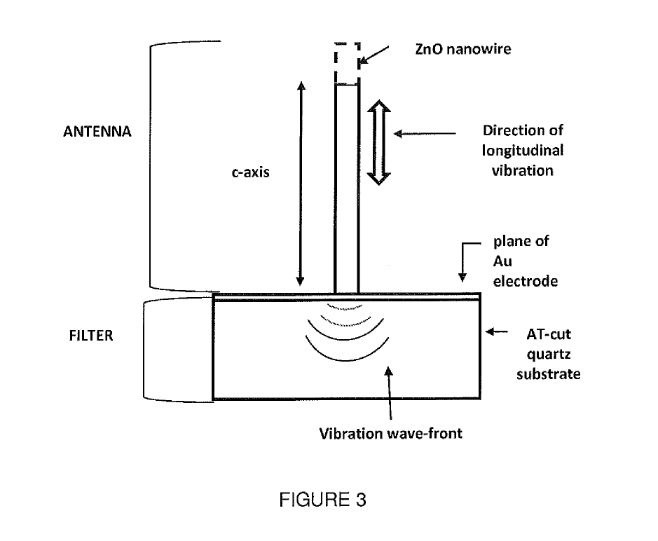

FIG. 3 is a partial schematic diagram showing another view of the construction of an oscillator contained in the oscillator carrier of the example of FIG. 1; and

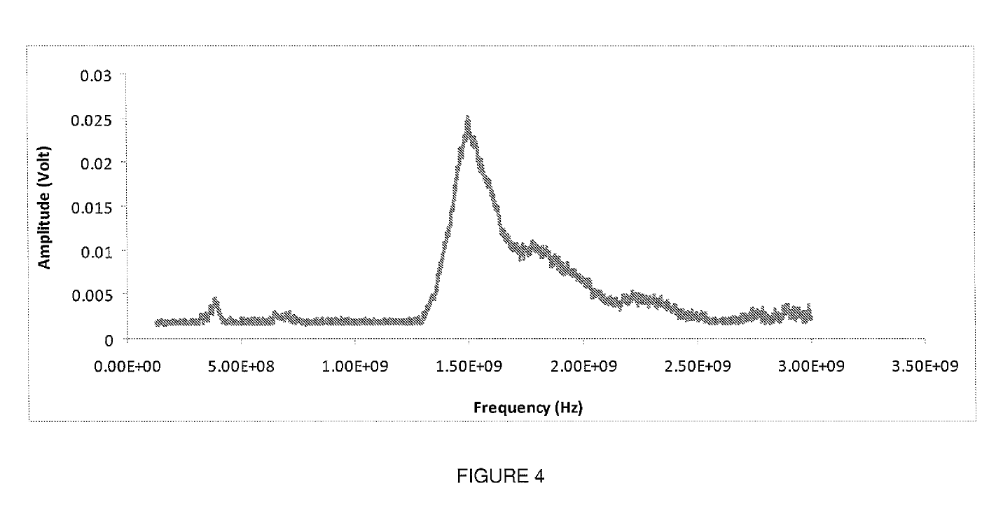

FIG. 4 is a graph showing the electrical characteristics of an antenna in accordance with one embodiment of the present invention.

FIG. 1 represents a diagram of a transceiver 1 in accordance with one embodiment of the present invention. The transceiver comprises an antenna 9 in accordance with the present invention, which itself comprises an oscillator carrier 6 and an oscillator 8. The antenna 9 is connected to a processor 7, by way of a power amplifier 4 and a demodulator 5, in order to effectuate reception of a signal, and by way of a modulator 3 and a low noise amplifier 2, in order to effectuate transmission of a signal. As will be appreciated, FIG. 1 shows an exemplary transceiver in accordance with the present invention. The skilled reader will understand that the present invention can be used with other transmitters, receivers or transceivers which may include other features than those shown in FIG. 1.

FIG. 2 shows a circular oscillator 8 in accordance with the present invention. As can be seen, oscillator 8 comprises a thick supporting region of piezoelectric material, as well as a co-centric ultra-thin piezoelectric region. The oscillator 8 also comprises an upper electrode and a lower electrode situated on either side of oscillator 8. The upper and lower electrodes extended from the centre of the ultra-thin piezoelectric region to the edge of the thick supporting region, where electrical contacts are located to connect the antenna to the rest of the transceiver.

An array of nanowires (not shown) is provided on at least the upper surface of the upper electrode. Because the signal strength of the antenna will be proportional to the number of nanowires on the surfaces of the crystal, it is also possible to cover the lower surface of the crystal with a nanowire coating. Provided that the upper and lower sides of the crystal are in the same field, and because the nanowires on opposite sides of the crystal will have opposite polarisation, which will result in a consistent resonance of the nanowires with respect to the half wave of the piezoelectric material, nanowires on opposite sides of the crystal will work together to increase the signal strength.

In the present embodiment, the array is made of individual piezoelectric nanowires disposed perpendicularly (i.e. along the c-axis) to the electrode. The array of nanowires is provided on at least part of the upper surface of the upper electrode. The array layer may also be partially grown on at least part of the ultra-thin piezoelectric region. In order to facilitate growth of the nanowires on the electrode, the piezoelectric material used for the nanowires is lattice matched to the electrode material. This lattice matching is the result of epitaxial deposition. In a preferred embodiment of the invention, the nanowires are formed of zinc oxide (ZnO) and the electrodes are formed of gold (Au), as explained below.

The ultra-thin piezoelectric region acts as an acoustic cavity (i.e. a platform for collecting and storing acoustic energy from the nanowires or distributing acoustic energy to the nanowires) for the acoustic energy of the nanowire. Accordingly, the selection criteria for this acoustic cavity layer are that it should allow growth of vertical c-axis oriented piezoelectric nanowires in order to optimise the electromechanical coupling coefficient of the piezoelectric, be able to provide significant acoustic energy to the nanowires by focusing the vibratory energy to the region where the nanowires are deposited. In addition, this region should be as small as possible such that the difference in the thickness and mass of the acoustic cavity layer and the nanowire layer is minimised.

In a preferred embodiment, photolithographic and etching processes are used (collectively known as inverted mesa technology), to acquire responsive AT-cut quartz substrates as thin as 15 μm. The ZnO nanowires are grown to lengths that significantly perturb the frequency of the quartz crystal oscillator and elicit identifiable frequency islands within the acoustic cavity layer's natural resonance spectrum. Using this structure the energy of the nanowire layer is coupled to that of the acoustic cavity layer.

The most common methods that have been used for ZnO nanowire synthesis in the prior art include vapour-liquid-solid (VLS) epitaxy, chemical vapour deposition (CVD), pulse laser deposition (PLD) and hydrothermal synthesis. The preferred method used in accordance with the present invention is hydrothermal synthesis. The main advantage of this method is the required growth temperature, which is below 100° C. Most of the acoustic devices which can be advantageously used with the present invention are not designed to withstand temperatures higher than 350° C. Heating these devices to temperatures of 350° C. or above for an extended period of time can result in serious damage to those devices. Moreover, high temperatures can also change the material properties of the device components that affect the electrical properties and ultimately the performance of the device.

Because the present invention relies on growing nanowires on acoustic devices, it is essential to ensure that the material properties of the device components do not alter during the growth process.

Hydrothermal growth also provides scope for changing the parameters that affect the nanowire fabrication with relative ease. This is also important, as a method in accordance with the present invention aims to optimise the growth parameters in order to achieve the required nanowire dimensions.

ZnO nanowires prepared hydrothermally are well aligned, single crystalline structures and have minimum defects. These properties are also important as any defects or impurities in the nanowire crystals can influence their vibration as well as acoustic behaviour. Furthermore, when compared to other methodologies, hydrothermal synthesis is environmentally benign and inexpensive.

Finally, hydrothermal growth methods are also substrate independent and produce high quality nanowire arrays on surfaces such as ITO glass, gold, sapphire, quartz, titanium foil and polymer surfaces.

The growth method of the nanowires in accordance with one embodiment of the present invention will now be explained. In the method in accordance with one embodiment of the present invention, the growth of nanowires takes place in an aqueous environment with external temperatures up to approximately 100° C.

Before introducing the quartz substrate into the aqueous solution, it is deposited with a uniform layer of single crystalline ZnO also known as the seed layer. This layer provides an active site for nucleation of ZnO that leads to the formation of ZnO nanowires during the growth process. The seed layer can be deposited either by using a spin coating method, or by sputter coating method.

Using a spin coating method, a seed solution is created by dissolving zinc acetate dehydrate (C4H10O6Zn, Mw=219.5 g) in 1-propanol. The ratio is 10.98 mg of zinc acetate to 5 ml of 1-propanol (0.01 M solution). The seed solution is ultrasonicated and shaken to promote complete dissolution of the zinc acetate.

Once a clear solution is obtained, the solution is pipetted onto a silicon substrate, so as to cover completely the surface. The substrate is then spun at 2000 rpm for 30 seconds in a spin coater. Afterwards it is annealed on a hot plate at 120° C. for 1 minute to remove excess solvent and seal any zinc acetate particles to the surface.

Typically the spin procedure is repeated three times so as to obtain a dense layer of seeds. Bulk zinc acetate decomposes at 237° C. Because of the size of the particles the decomposition temperature is unlikely to be much less than this. If the temperature of the hot plate used for annealing between spins is increased to 200-250° C., the temperature is sufficiently high for decomposition of the dispersed zinc acetate to take place. Decomposition of zinc acetate leads to the formation of zinc oxide nanoclusters (seeds):

2Zn(CH3COO)2+7O2_{—}2ZnO+8CO2+6H2O

Preferably, and for the purposes of the embodiment described in the present disclosure, a sputter coating method is used. For this, the sputter coater is pumped down to below 10⁻⁵ mbar and the base pressure adjusted to 2.7×10⁻⁴ mbar by pumping 15 sccm of argon into the chamber.

The sputtering is performed with an a.c. source with a peak voltage of 125 V and a dc bias of 250 V; 10 sccm of oxygen and 20 sccm of argon are used to create the sputter plasma. The target is pure zinc metal and is pre-sputtered for a approximately 5 minutes before exposing the sample. This is to sputter off any impurities on the target surface and allow reaction with the oxygen such that a thin layer of ZnO is formed on the target which can be sputtered onto the sample. Sputtering then proceeded at a rate of approximately 3.1 nm/min.

Once the substrate has been coated, it is then placed in the aqueous solution in order to begin growing the nanowires on the seed layer. To do this, an equimolar (0.06M) solution of zinc nitrate hydrate [Zn(NO₃)₂.6(H₂O), molar mass 297 g] and hexamethylenetetramine [HMTA, C₆H₁₂N₄, molar mass 140.186 g] in DI water is prepared. Typically, 200 ml flasks are utilised. Shaking and some ultrasonication is utilised to ensure dissolution of the zinc nitrate and HMTA. The growth temperature is 92° C.

Zinc nitrate salt provides Zn²⁺ ions required for building up the ZnO nanowires. The HMTA acts as a pH buffer to regulate the pH value (approximately 6) of the solution and the slow supply of OH⁻ ions. This can be explained by the following reaction:

C₆H₁₂N₄(aq)+10H₂O(I)→6H₂CO(aq)+4NH₄⁺(aq)+4OH⁻(aq)

The OH— reacts with Zn2+ to form zinc hydroxide [Zn(OH)2] species. The Zn(OH)2 then transforms into ZnO crystals:

Zn²⁺+OH⁻→Zn(OH)₂(aq)

Δ

Zn(OH)₂(aq)→ZnO(s)+H₂O(I)

The seed layer acts as a focus for crystallisation. The substrates (oscillators) are placed in the solution sideways, such that any larger particles of zinc oxide that form independently do not collect on the surface. After growth, the samples are removed from the solution, rinsed with DI water and dried with nitrogen.

With reference to FIG. 3, the electro-acoustic interactions between the atomically connected nanowire layer, electrode layer and acoustic cavity layer will now be described.

Interacting nanowires or nanotubes with electromagnetic waves is known to lead to electronic changes; for example, at optical frequencies, carbon nanotubes act as antennas due to the resonant electron modes that result for exposure to the electromagnetic field. Similarly, nanowires can also operate as antennas, though these have the advantage of working in the GHz frequency range normally reserved for all forms of wireless communication. This is because their resonant electro-acoustic modes are several orders of magnitude shorter so they can vibrate in the microwave region of the spectrum. Evidence for microwave coupling relates to the zinc oxide nanotree structures which have strong microwave absorption and, due to their antenna-like behaviour, dissipate energy locally.

FIG. 3 shows a single nanowire on an electrode, which electrode is provided on an acoustic cavity, as shown in FIG. 2. As will be appreciated, a device in accordance with the present invention will comprise an array of such nanowires grown on the upper electrode, as well as a lower electrode beneath the acoustic cavity, which acoustic cavity consists of the thick quartz support and the 15.5 μm thick mesa region shown in FIG. 2.

In order to achieve low energy loss in a high damping medium such as air or water, all nanowires in the array should be arranged to vibrate with either torsional or longitudinal modes. This is because the surface of a longitudinally or torsionally vibrating nanowire expands and contracts in the direction of the load exerted by the surrounding medium. This is similar to shear horizontal displacement of a quartz crystal microbalance (QCM), which allow it to operate in liquid without excessive damping. This vibration of the nanowire surface parallel to the direction of the load (in the case of flexural mode) results in compressional waves in high damping mediums, which causes attenuation. Therefore, longitudinal or torsional vibration is important for the nanowires to operate efficiently in high damping environments.

In order to achieve these modes, it is important to grow the nanowires to precisely the right dimensions. In general, the relationship between longitudinal mode frequency and the length of the nanowire can be represented by the following equation, where F is the frequency of the longitudinal mode, L is the length of the nanowire, E_{ZZ} is the Young's Modulus of the nanowire, ρ is the mass density of the nanowire and n (positive integer) is the harmonic number.

$$F = \frac{2 n - 1}{4 L} \sqrt{\frac{{E}_{ZZ}}{ρ}}$$

To ensure that the torsional or longitudinal vibrational energy reaches the acoustic cavity, a lattice match is used to allow the phonons to pass easily from the nanowires to the acoustic cavity. For example, in the abovementioned preferred embodiment, a nanometer-thick gold film fuses the atomic positions of the zinc oxide with the quartz substrate such that phonon transfer from the nanowires to the acoustic cavity at high (GHz) frequencies is possible. In this embodiment, it is also preferable to make the mesa crystal thickness within an order of magnitude of the nanowire length, such that energy from the nanowires compares favourably with that of the quartz substrate.

Accordingly, the acoustic cavity captures the phonon energy from the nanowires and passes the integrated signal to the receiver. Furthermore, because the acoustic cavity acts as a piezocavity, it also amplifies the energy from the nanowires. This is a major advantage of the present invention.

As will be appreciated, whilst the above explanation relates to the reception of electromagnetic waves, the present invention can also be used to transmit electromagnetic waves. In the case of transmission, the nanowires receive phonon energy from the acoustic cavity, which in turn induces electroacoustic resonance in the nanowires. This reciprocal phenomenon will be readily understood by the skilled reader.

As mentioned above, one of the key requirement to enhance acoustic coupling between the nanowire layer and the acoustic cavity layer is to reduce the size and mass of the acoustic cavity layer to within an order of magnitude of that predicted by the nanowire density and length. For example, when the present invention is implemented using an inverted mesa etched acoustic oscillator comprising an AT-cut quartz 100 MHz fundamental oscillator with a mesa diameter 3 mm, a gold electrode thickness 623 nm, mesa thickness 15.569 μm, support thickness 68.6 μm and electrode diameter 762 μm, the resulting antenna exhibits the electrical characteristics shown in FIG. 4.

The output signal obtained in FIG. 4 can only be achieved when nanowires of the above dimension profile are grown on the Au+Quartz oscillator. In this embodiment, the parameters used are as follows:

Temperature: 87 to 90 Deg C.

Thickness of seed layer

(AC sputtered) on the

(111)oriented Au layer: 17 nm

Volume of the flask: 200 ml

Growth time: 2 hours

By using these parameters, it is possible to achieve the dimension profile which provides the output signal shown in FIG. 4. This is because most of the nanowires (80%) of this dimension profile have their frequency of fundamental longitudinal mode either at or close 1.5 GHz.

It is also possible to change the above parameters in order to change the dimension of the nanowires. This will in turn change the fundamental frequency of different modes (longitudinal or torsional).

Different embodiments of the present invention will provide different antennas based on electro-acoustic resonance. Each of these antennas will comprise a second lattice matched acoustic cavity to collect vibrational energy from the nanowires. Moreover, each of the antennas will require frequency tuning of the nanowires to produce torsional and longitudinal resonance modes.

In many ways the electro-acoustic antenna of the present invention is similar to a conventional antenna, as it will work with either a half wave or quarter wave across the nanowire. What distinguishes the antenna of the present invention however is that the electrical component of the electromagnetic waves is unified with the acoustic waves. Thus, the electrical component of the electromagnetic waves and the acoustic waves are forced to move together as one. Moreover, the acoustic wave significantly alters the behaviour of the whole antenna, so that it performs as a far more compact element (roughly five orders of magnitude smaller) than the electrical wire equivalent.

Another advantage of the present invention is that it is possible to produce a small change (in the order of approximately 1%) in the stiffness of the nanowires or the acoustic cavity by exposing these to an external DC electric field. As will be appreciated, the intensity of the DC field will be proportional to the change in stiffness, the result of which is a change in the operational frequency of the antenna. Accordingly, by exposing the antenna to a DC electric field, it is possible to fine tune to the operating frequency of the antenna.

No doubt many other effective alternatives will occur to the skilled person. It will be understood that the invention is not limited to the described embodiments and encompasses modifications apparent to those skilled in the art lying within the spirit and scope of the claims appended hereto.

1-11. (canceled)

12. An antenna for wireless telecommunication, the antenna comprising:
a piezoelectric material layer, the piezoelectric material layer being formed such that when an electromagnetic wave is applied thereto, the first piezoelectric material layer is excited at the frequency of the electromagnetic wave;
an acoustic cavity layer arranged to collect the acoustic energy received from the first piezoelectric layer; and
first and second electrode layers positioned on either side of the acoustic cavity layer, the electrode layers being arranged to transfer electrical energy to and from both the piezoelectric material layer and the acoustic cavity layer.

13. An antenna in accordance with claim 12, wherein the piezoelectric material layer is arranged to cover at least part of the acoustic cavity layer and part of the first electrode layer.

14. An antenna in accordance with claim 12, wherein the acoustic cavity layer also comprises piezoelectric material.

15. An antenna in accordance with claim 12, wherein the piezoelectric material layer comprises a layer of nanowires disposed perpendicularly with respect to the second piezoelectric material layer.

16. An antenna in accordance with claim 12, wherein:
the piezoelectric material is formed of zinc oxide;
the acoustic cavity layer is formed of quartz; and
the first and second electrode layers are formed of gold.

17. An antenna in accordance with claim 12, wherein the acoustic cavity layer comprises:
a round thick support layer; and
a co-centric round thin mesa region disposed in the centre of the round thick support layer.

18. An antenna in accordance with claim 17, wherein the mesa region comprises a first and a second surface, and the first and second electrode layers are arranged to cover at least a portion of the first and second surfaces of the mesa region.

19. An antenna in accordance with claim 13, wherein a further piezoelectric material layer is provided on the second electrode layer.

20. An antenna in accordance with claim 19, wherein the further piezoelectric material layer is formed of zinc oxide nanowires.

21. An antenna in accordance with claim 12, wherein the antenna further comprises:
electric field generating means for generating a direct current electric field around at least one of the piezoelectric layer and the acoustic cavity layer,
the electric field generating means being arranged to vary the intensity of the direct current electric field in order to tune the resonant frequency of the antenna.

22. A transceiver for wireless telecommunications, the transceiver comprising an antenna in accordance with claim 12.
